(19) United States
(12) Patent Application Publication
(10) Pub. No.: US 2026/0163031 A1
(43) Pub. Date: Jun. 11, 2026

(54) FUEL CELL SYSTEM

(71) Applicant: TOYOTA JIDOSHA KABUSHIKI KAISHA, Toyota-shi (JP)

(72) Inventors: Seiichi TANAKA, Nagoya-shi (JP); Kazuo YAMAMOTO, Toyota-shi (JP); Tsuyoshi MARUO, Okazaki-shi (JP); Shuya KAWAHARA, Toyota-shi (JP)

(73) Assignee: TOYOTA JIDOSHA KABUSHIKI KAISHA, Toyota-shi (JP)

(21) Appl. No.: 19/380,782

(22) Filed: Nov. 5, 2025

(30) Foreign Application Priority Data
Dec. 6, 2024 (JP) 2024-213801

(51) Int. Cl. H01M 8/04223; H01M 8/04082; H01M 8/0432; H01M 8/04537

(52) U.S. Cl. CPC H01M 8/04253; H01M 8/04201; H01M 8/04358; H01M 8/04574; H01M 8/04634

(57) ABSTRACT

A fuel cell system that includes an ejector on a path for introducing hydrogen into a fuel cell stack includes a control device, in which the control device acquires impedance when a current value of the fuel cell stack, a coolant temperature at an outlet of the fuel cell stack, and an atmospheric pressure, are each within a predetermined range, and when the impedance is greater than a predetermined threshold value, determination is made that the ejector is blocked.

### CROSS-REFERENCE TO RELATED APPLICATION

This application claims priority to Japanese Patent Application No. 2024-213801 filed on Dec. 6, 2024. The disclosure of the above-identified application, including the specification, drawings, and claims, is incorporated by reference herein in its entirety.

### BACKGROUND

### 1. Technical Field

The present disclosure relates to a fuel cell system.

### 2. Description of Related Art

Japanese Unexamined Patent Application Publication No. 2007-278191 (JP 2007-278191 A) describes a system for determining ejector blockage based on ejector suction pressure.

Japanese Unexamined Patent Application Publication No. 2021-097022 (JP 2021-097022 A) describes a point of performing purging of an ejector when external air temperature is below freezing.

WO 2016/021182 describes a technology that determines that there is an ejector abnormality (blockage abnormality of circulation channel between ejector and pressure detection unit) when a detection result of a pressure sensing unit that senses pressure of circulating hydrogen does not fall below a predetermined threshold value.

### SUMMARY

In a fuel cell system that uses an ejector as a hydrogen supply device, using the ejector has an advantage in that size of the system can be reduced, but the ejector has a tendency to become clogged with foreign matter and the like due to a channel thereof being narrow. In order to perform sensing of blockage, various sensors such as a flow rate sensor, a pressure sensor, and so forth, have to be installed, which poses problems in terms of installability and cost.

The present disclosure provides a fuel cell system that senses blockage without having to install various additional sensors for the purpose of detecting blockage.

The present application discloses a fuel cell system that includes an ejector on a path for introducing hydrogen into a fuel cell stack, including a control device, in which the control device acquires an impedance when a current value of the fuel cell stack, a coolant temperature at an outlet of the fuel cell stack, and an atmospheric pressure are each within a predetermined range, and when the impedance is greater than a predetermined threshold value, determination is made that the ejector is blocked.

A configuration may be made in which, when determination is made that the ejector is blocked, the control device determines that the ejector is frozen when the coolant temperature or an external air temperature at a time of starting the fuel cell system is equal to or lower than 0° C., and the control device determines that the ejector is blocked by foreign matter when the coolant temperature or the external air temperature at the time of starting the fuel cell system is higher than 0° C., and when determination is made that the ejector is frozen, deicing processing is performed until the impedance becomes smaller than the predetermined threshold value.

The deicing processing may be processing for performing hydrogen pressure pulsation, or transferring heat from increase in fuel cell stack coolant temperature that is caused by low-efficiency electric power generation.

According to the fuel cell system of the present disclosure, there is no need to install various additional sensors for the purpose of sensing blockage, and accordingly blockage sensing can be performed while improving installability and suppressing costs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a configuration of a fuel cell system 10;

FIG. 2 is a diagram showing a flow of foreign matter determination control (form 1);

FIG. 3 is a diagram showing a flow of foreign matter determination control (form 2); and

FIG. 4 is a diagram showing an example of deicing processing.

### DETAILED DESCRIPTION OF EMBODIMENTS

### 1. Configuration of Fuel Cell System

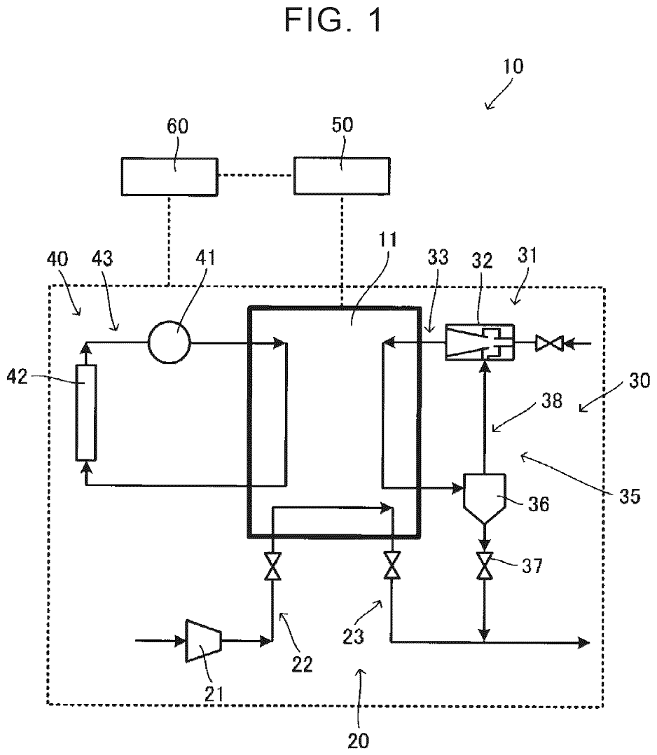

FIG. 1 is a schematic illustration of a configuration of a fuel cell system 10 according to one embodiment. As can be seen in FIG. 1, the fuel cell system 10 of the present embodiment includes a fuel cell 11, an oxygen gas supply path 20, a fuel gas supply path 30, a coolant supply path 40, a boost converter 50, and a control device 60. Motive power is obtained by rotating a motor using electric power that is generated by the fuel cell 11, or the like.

### 1.1. Fuel Cell

The fuel cell 11 is widely known, in which a stack, which is obtained by stacking a plurality of fuel-cell cells, is housed in a stack case, for example. A fuel-cell cell is configured by sandwiching a membrane electrode assembly (MEA) between two separators. The MEA is a laminate including a solid polymer membrane, an anode catalyst layer, a cathode catalyst layer, an anode gas diffusion layer, a cathode gas diffusion layer, and so forth. The fuel cell 11 receives supply of oxygen gas and fuel gas (hydrogen gas in the present embodiment), and generates electric power. The supply of oxygen gas and fuel gas to the fuel cell 11 and discharge from the fuel cell 11 are performed through the oxygen gas supply path 20 and the fuel gas supply path 30.

Here, the oxygen gas and the fuel gas are reactant gases for generating electricity in the fuel cell. As described above, oxygen gas and fuel gas are supplied to the fuel cell for electric power generation, while gases that were not used in electric power generation are discharged from the fuel cell as oxygen off-gas and fuel off-gas. Also, in the following, an example will be described in which air is used as the oxygen gas and hydrogen gas is used as the fuel gas. Accordingly, the oxygen off-gas may be referred to as air off-gas, and the fuel off-gas may be referred to as hydrogen off-gas.

### 1.2. Oxygen Gas Supply Path 20

The oxygen gas supply path 20 includes a compressor 21, a supply channel 22, and a discharge channel 23. Components that are well known may be applied to the components with which the oxygen gas supply path 20 is equipped. That is to say, atmospheric air that is taken in by the compressor 21 flows through the supply channel 22 and is supplied to the fuel cell 11. The air off-gas that is discharged from the fuel cell 11 flows through the discharge channel 23 and is externally discharged. The supply channel 22 and the discharge channel 23 are provided with valves as necessary.

### 1.3. Fuel Gas Supply Path 30

The fuel gas supply path 30 includes a supply system 31 and a circulation system 35.

### 1.3a. Supply System

The supply system 31 is a path for supplying hydrogen gas to the fuel cell 11, and in the present embodiment, the supply system 31 has an ejector 32 and a supply channel 33.

The ejector 32 ejects hydrogen gas that is supplied from a hydrogen source such as a hydrogen tank or the like, thereby supplying the hydrogen gas to the fuel cell 11. In addition, the ejector 32 suctions hydrogen off-gas from the circulation system 35 and performs supply thereof to the fuel cell 11 along with hydrogen gas from the hydrogen source.

The specific form of the ejector 32 is not limited in particular, and a known form can be applied. That is to say, the ejector generates a low-pressure space within a housing by ejecting gas at high speed from a nozzle, thereby suctioning external fluid. The gas that is ejected at high speed from the nozzle is mixed with the suctioned fluid and flows out of the ejector while reducing speed thereof in a diffuser.

In the present embodiment, the ejector 32 ejects hydrogen gas from the hydrogen source through the nozzle toward the diffuser. Hydrogen off-gas from the circulation system 35 is suctioned into the low-pressure space that is created inside the housing by the ejection of hydrogen gas from the nozzle, enters the diffuser through a suction port, is mixed with the hydrogen gas that was ejected from the nozzle, and flows out from the ejector 32.

The supply channel 33 is a channel that supplies hydrogen gas to the fuel cell 11, and has piping for the hydrogen gas to flow from the ejector 32.

### 1.3b. Circulation System

The circulation system 35 returns the hydrogen off-gas that is contained in fluid that is discharged from a gas outlet of the fuel cell 11 to the supply system 31. To this end, in the present embodiment, the circulation system 35 has a gas-liquid separator 36, a drain valve 37, and a circulation channel 38. The gas-liquid separator 36 separates the fluid that is discharged from the gas outlet of the fuel cell 11 into liquid and gas. This liquid is water that is produced by reaction in the fuel cell 11, and after being separated in the gas-liquid separator 36, is externally discharged by opening the drain valve 37. The gas is hydrogen off-gas, which is separated in the gas-liquid separator 36 and then suctioned into the low-pressure space of the ejector 32 as described above, and is mixed with the hydrogen gas in the supply system 31.

The circulation channel 38 is a channel for the fluid that is discharged from the fuel cell 11 to flow through, and includes piping that connects the components that are described above, such that the fluid flows therebetween. That is to say, the circulation channel 38 includes piping that connects the fuel cell 11 to the gas-liquid separator 36, the gas-liquid separator 36 to the ejector 32, and the gas-liquid separator 36 to the drain valve 37.

### 1.4. Coolant Supply Path 40

The coolant supply path 40 includes a pump 41, a radiator 42, and a circulation channel 43. Components that are well known can be applied to the components that the coolant supply path 40 is equipped with. That is to say, the coolant forced out by the pump 41 flows through the circulation channel 43 and is supplied to the fuel cell 11. The coolant that is supplied cools the fuel cell 11 and becomes warmer, and is discharged from the fuel cell 11. The coolant that is discharged flows through the circulation channel 43 and enters the radiator 42, where the coolant is cooled by performing heat exchange with the ambient air. The coolant leaving the radiator 42 flows through the circulation channel 43 and is supplied to the pump 41 again.

### 1.5. Boost Converter

The boost converter 50 is a unit of which a main unit is installed in the fuel cell 11 and boosts the voltage from the fuel cell that converts hydrogen into electricity, so as to supply electric power to devices that use the electricity that is generated by the fuel cell, such as the motor and so forth. The boost converter includes the main unit and a controller (electronic control unit) that controls the main unit, with the main unit and the controller being electrically connected together, either by wired or wireless connection.

### 1.6. Control Device

The control device 60 is a control device including electronic circuits, and is made up of a so-called computer. Accordingly, the control device 60 includes a central processing unit (CPU), random access memory (RAM), storage, a receiver, and a transmitter. The central processing unit performs computation according to programs that are stored in the storage, and based on the computation results, transmits signals indicating the contents thereof to each piece of equipment that should follow the computation results. The storage stores programs to be subjected to processing by the central processing unit, and the results that are obtained by the computation.

The RAM is used as various types of working areas for computation processing.

The receiver is a so-called input port or the like, and is a portion that takes in data and so forth that is to be externally obtained into the control device 60. In the present embodiment, the receiver is communicatively connected to a temperature sensor, an ammeter, a voltmeter, and a pressure gauge, for obtaining data regarding temperature, electric current, and pressure, which are needed for performing foreign matter determination control that will be described later, and is configured so as to be capable of inputting the data into the control device 60 as a signal.

The transmitter is a so-called output port or the like, and outputs commands and the like to be output from the control device 60 to each piece of equipment, based on the computation results. In the present embodiment, the transmitter is communicatively connected to the boost converter 50.

Foreign matter determination control performed by the control device 60 will be described in detail later, but the control device 60 determines blockage of the ejector 32 based on information from a sensor that is originally provided in the fuel cell system for a different purpose.

### 2. Operations of Fuel Cell System

Electric power generation by the fuel cell system 10 will be described below.

### 2.1. Basic Flow of Electric Power Generation

First, a basic flow of electric power generation by the fuel cell system 10 will be described.

Air is supplied to the fuel cell 11 through the oxygen gas supply path 20. Specifically, atmospheric air that is taken in by the compressor 21 flows through the supply channel 22 under pressure, and is supplied to the fuel cell 11. The oxygen off-gas (air off-gas) discharged from the fuel cell 11 flows through the discharge channel 23 and is externally discharged.

On the other hand, hydrogen gas is supplied to the fuel cell 11 through the fuel gas supply path 30. Specifically, hydrogen gas from the hydrogen source enters the nozzle of the ejector 32, and is ejected from the nozzle into the diffuser. The hydrogen gas flowing out from the diffuser is supplied to the fuel cell 11.

Further, water that is produced by the reaction, and hydrogen off-gas that was not used for electric power generation, are discharged from the fuel cell 11 and enter the gas-liquid separator 36. The gas-liquid separator 36 separates the liquid into water and hydrogen off-gas. The water that is separated is drained via the drain valve 37. The hydrogen off-gas that is separated heads toward the ejector 32. At the ejector 32, hydrogen off-gas is suctioned into the low-pressure space created inside the housing by the ejection of hydrogen gas from the nozzle, enters the diffuser through the suction port, is mixed with the hydrogen gas that is ejected from the nozzle, flows out of the ejector 32, and is supplied to the fuel cell 11 again.

Also, coolant is supplied to the fuel cell 11 through the coolant supply path 40, whereby temperature management is performed.

Thus, air and hydrogen gas are supplied to the fuel cell 11 for electric power generation, thereby driving the motor, for example, that is electrically connected to the fuel cell 11. This motor is a drive source by which an automobile travels or airplane flies, for example.

### 2.2. Foreign Matter Determination Control (Form 1)

In this form, the foreign matter determination control can be performed by the control device 60 that is described above, for example.

### 2.2a. Flow of Control

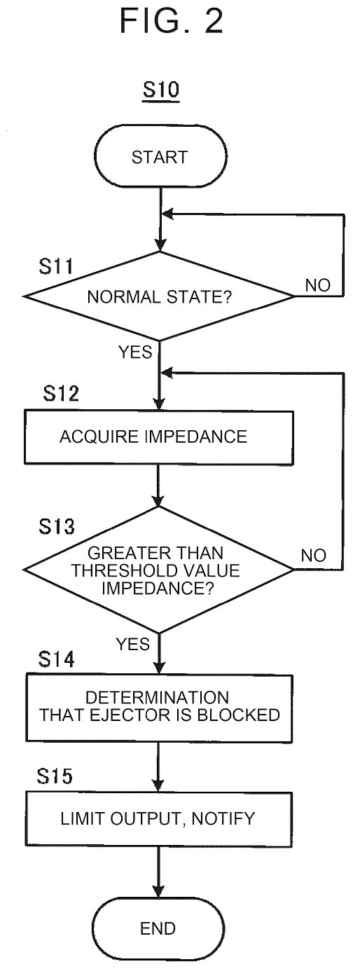

The fuel cell system 10 according to this form performs control to determine blockage of the ejector 32, in addition to the basic electric power generation that is described above. FIG. 2 shows a flow of foreign matter determination control S10 according to Form 1. Each step will be described below.

### Step S11

In step S11, determination is made regarding whether the present state is a normal state. Here, the term “normal state” means that a current value at the fuel cell stack, temperature of the coolant at the outlet of the fuel cell stack, and atmospheric pressure, are all within predetermined ranges that are each set.

The current value of the fuel cell stack can be obtained from an existing ammeter, the temperature of the coolant at the outlet of the fuel cell stack can be obtained from an existing thermometer, and the atmospheric pressure can be obtained from an existing barometer, none of these having been installed exclusively for foreign matter control S10.

When determination is made that the present state is the normal state, “Yes” is returned, and the processing advances to step S12. On the other hand, when determination is made that the present state is not the normal state, “No” is returned, and the determination of step S11 is performed again.

### Step S12

In step S12, the present impedance of the fuel cell stack is acquired. The fuel cell impedance is also acquired during normal operations, and accordingly it is sufficient to use the value thereof.

### Step S13

In step S13, determination is made regarding whether the impedance that is acquired in step S12 is greater than a threshold value impedance. When the ejector is blocked by foreign matter or the like, this impedance rises. The threshold value impedance can be decided based on a relation between blockage of the ejector and the impedance, which is obtained in advance by experimentation or the like.

When the impedance that is acquired in step S12 is greater than the threshold value impedance, “Yes” is returned, and the processing advances to step S14. When the impedance that is acquired in step S12 is equal to or lower than the threshold value impedance, the processing returns to step S12 and the impedance is acquired again.

### Step S14, Step S15

In step S14, based on the result of step S13, determination is made that the ejector is at least partially blocked. Then in step S15, output is restricted, and also notification thereof is performed by means such as a screen, sound, light, or the like.

### 2.2b. Effects, Etc.

According to the control of the present embodiment, there is no need to prepare and install new sensors for sensing blockage of the ejector, and accordingly installability and costs can be improved. Also, there is no need for maintenance of special sensors for this control, such as regarding malfunctioning or freezing thereof. That is to say, utilizing the impedance measurement function enables blockage to be sensed by utilizing the existing impedance measurement function, without installing various types of sensors.

### 2.3. Foreign Matter Determination Control (Form 2)

The foreign matter determination control can be performed by the control device 60 that is described above, for example, in this form as well.

### 2.3a. Flow of Control

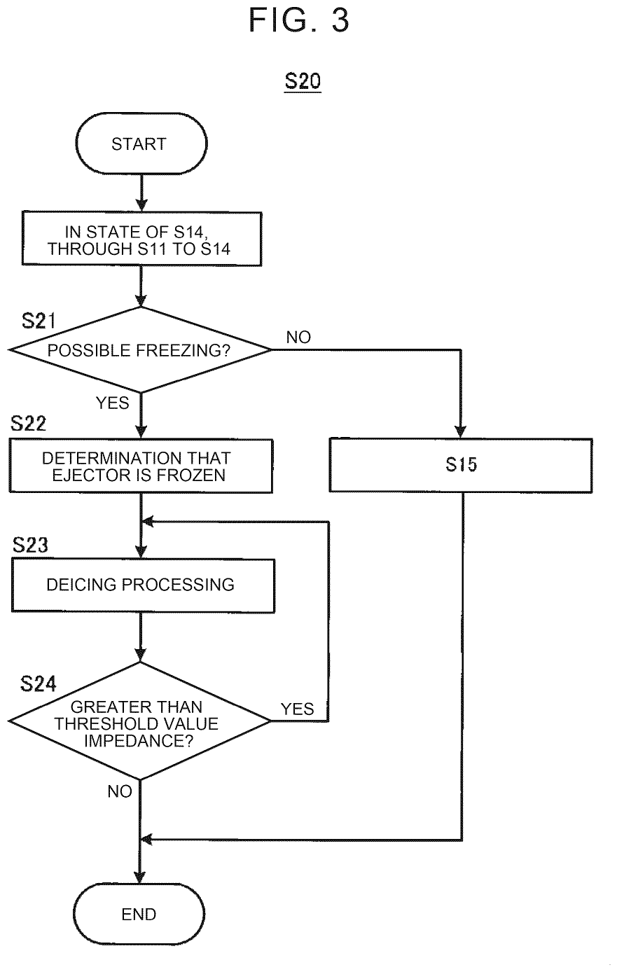

The fuel cell system 10 according to this form performs control to determine blockage of the ejector 32, in addition to the basic electric power generation that is described above. FIG. 3 shows a flow of foreign matter determination control S20 according to Form 2. Each step will be described below.

In this form, assumption is made that the above-described steps S11 to S14 have been performed, and that the state is that in step S14.

### Step S21

In step S21, determination is made regarding whether conditions, for determining whether blockage due to freezing, are satisfied. Specifically, determination is made regarding whether the temperature of the coolant at the outlet of the fuel cell stack when the fuel cell system is started is 0° C. or lower, or whether the current outside air temperature is 0° C. or lower. Each of these temperatures can be obtained by an existing temperature sensor.

When determination is made in step S21 that conditions are satisfied, “Yes” is returned, and the processing advances to step S22. On the other hand, when determination is made in step S21 that conditions are not satisfied, “No” is returned, and the processing returns to step S15 described above, in which the control ends.

### Step S22

In step S22, blockage of the ejector is determined to be caused by freezing, based on determination results from step S21.

### Step S23

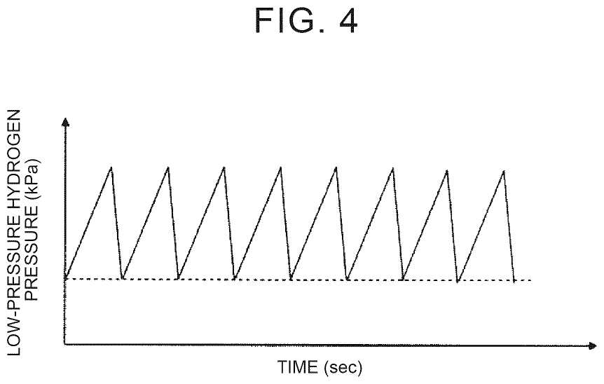

In step S23, deicing processing is performed based on determination results from step S22. The specific method for the deicing processing is not limited in particular, and deicing can be performed by transfer of heat, by pulsating the hydrogen pressure as shown in FIG. 4, raising the stack coolant temperature by low-efficiency electric power generation, and so forth.

### Step S24

In step S24, determination is made regarding whether the impedance that is acquired in step S12 is greater than the threshold value impedance. The relation between impedance and blockage is as described above.

When the impedance acquired in step S12 is greater than the threshold value impedance, “Yes” is returned, and the processing returns to step S23 to continue deicing. When the impedance acquired in step S12 is equal to or lower than the threshold value impedance, the blockage has been resolved, and accordingly the control ends.

### Other

When steps S23 and S24 are repeated a predetermined number of times, determination may be made that the blockage is not due to freezing, and control may be performed to advance to step S15.

### 2.3b. Effects, Etc.

According to the control of the present embodiment, there is no need to prepare and install new sensors for sensing blockage of the ejector, and accordingly installability and costs can be improved. Also, there is no need for maintenance of special sensors for this control, such as regarding malfunctioning or freezing thereof. That is to say, utilizing the impedance measurement function enables blockage to be sensed by utilizing the existing impedance measurement function, without installing various types of sensors. Furthermore, deicing processing can be performed upon having distinguished between blockage caused by foreign matter and blockage caused by freezing. Thus, hydrogen shortage caused by freezing blockage can be circumvented, and deterioration of the fuel cell can be circumvented.

What is claimed is:

1. A fuel cell system that includes an ejector on a path for introducing hydrogen into a fuel cell stack, the fuel cell system comprising a control device, wherein:
the control device acquires an impedance when a current value of the fuel cell stack, a coolant temperature at an outlet of the fuel cell stack, and an atmospheric pressure are each within a predetermined range; and
when the impedance is greater than a predetermined threshold value, determination is made that the ejector is blocked.

2. The fuel cell system according to claim 1, wherein:
when determination is made that the ejector is blocked, the control device determines that the ejector is frozen when the coolant temperature or an external air temperature at a time of starting the fuel cell system is equal to or lower than 0° C., and the control device determines that the ejector is blocked by foreign matter when the coolant temperature or the external air temperature at the time of starting the fuel cell system is higher than 0° C.; and
when determination is made that the ejector is frozen, deicing processing is performed until the impedance becomes smaller than the predetermined threshold value.

3. The fuel cell system according to claim 2, wherein the deicing processing is processing for performing hydrogen pressure pulsation, or transferring heat from increase in stack coolant temperature that is caused by low-efficiency electric power generation.
